(19) United States
(12) Patent Application Publication
(10) Pub. No.: US 2007/0169634 A1
(43) Pub. Date: Jul. 26, 2007

(54) Beverage infuser system with positive locking

(75) Inventor: Aly Khalifa, Raleigh, NC (US)

Correspondence Address: AUFRICHTIG STEIN & AUFRICHTIG, P.C., 300 EAST 42ND STREET, 5TH FLOOR, NEW YORK, NY, 10017, US

(73) Assignee: Gamila Company

(21) Appl. No.: 11/639,758

(22) Filed: Dec. 15, 2006

Related U.S. Application Data
(60) Provisional application No. 60/750,512, filed on Dec. 15, 2005.

(51) Int. Cl. A47J 31/00

(52) U.S. Cl. 99/279

(57) ABSTRACT

A beverage infuser for holding tea leaves and the like having a main body, a handle region, an upper sliding region, a scooping region and a barb region. An end piece is secured to a bottom portion of the main body proximate to the barb region and a plug is located within the upper sliding region. A sleeve that is formed from a perforated material slides back and forth across the main body while retaining contact with the sliding region between an open scooping position and a closed locking position. A friction enhancing element is formed in the sleeve for creating a positive lock between the sleeve and the main body to keep the tea leaves securely inside the scooping region.

### CROSS-REFERENCE TO RELATED APPLICATIONS

This application claims the priority of provisional application Ser. No. 60/750,512 filed in the United States Patent and Trademark Office on Dec. 15, 2005.

### BACKGROUND OF THE INVENTION

The invention is generally directed to an infusion device for beverages in which natural products such as tea leaves may be securely held within the infuser so that water passes through, allowing a tea or similar beverage to be made without the tea leaves passing out of the infuser into the body of the liquid to be infused. In particular, the invention is generally directed to an improved beverage infuser in which the screen-like portion which allows the water to flow into the infusion chamber is positively maintained in its closed state without a separate locking mechanism.

In the past, various beverage infusers, generally used for making tea, have been developed, including a tea ball, which is formed of two semi-spherical screen elements which lock together at one side and are hinged at the other side so as to provide a infusion chamber for tea leaves which are then placed in a cup or other container for the hot water. Also, a spring loaded twin spoon type arrangement in which the screen elements are formed as two spoon shaped elements which are held together by the biasing force of the spring can be used to similar effect. In the past, these approaches have been utilized and found wanting for a variety of reasons, including the leakage of tea leaves and other natural matter in the infusion chamber into the beverage. The leakage seriously degrades the quality of the beverage being made with the infuser. In addition, these materials tend to be made in a flimsy fashion and are often damaged or bent during use.

Accordingly, there is a need for an improved form of beverage infuser suited for use in connection with tea leaves and other similar natural matter which can be infused in hot or cold water.

### SUMMARY OF THE INVENTION

The invention is generally directed to a beverage infuser including a main body having a handle region, an upper sliding region, a scooping region and a barb region, an end piece coupled to the bottom portion of the main body at the barb region and a perforated screen plug fixed within the diameter of the tube at the upper sliding region. A sleeve formed of a perforated material slides back and forth across the main body between a scooping position and a sealed position, but is always in contact with the sliding region. A positive contact section on the sleeve provides a frictional positive lock between the sleeve and the sliding region.

Accordingly, it is an object of the invention to provide an improved beverage infuser in which the sliding perforated screen is positively locked in position so that the tea leaves are prevented from escaping from the infusion chamber.

Another object of the invention is to provide an improved beverage infuser in which the sliding perforated screen is positively locked in position so that the user can feel the locking.

Still another object of the invention is to provide an improved beverage infuser in which the sliding perforated screen is positively locked in position by the final sliding of the perforated screen so that the user can feel the frictional engagement of the sliding perforated screen and the main body of the beverage infuser as the two lock in the sealed position.

Still other objects and advantages of the invention will, in part, be obvious and will, in part, be apparent from the specification.

The invention accordingly comprises the features of construction, combinations of elements and arrangements of parts which will be exemplified in the construction as hereinafter set forth, and the scope of the invention will be indicated in the Claims.

### BRIEF DESCRIPTION OF THE DRAWINGS

FIG. 1 is a top plan view of a beverage infuser constructed in accordance with a preferred embodiment of the invention;

FIG. 2 is a cross-sectional view along the lines A-A of FIG. 1;

FIG. 3 is a top plan view similar to the view of FIG. 1, in which the sleeve is moved outwardly from it's locked position;

FIG. 4 shows cross-sectional view along the lines A-A of FIG. 3;

FIG. 5 shows a cross-sectional view where the sleeve is shown apart from the main body of the beverage infuser;

FIG. 6 shows a partial cross-section view of Section B of FIG. 2 of the beverage infuser showing the friction element in its locked position;

FIG. 7 shows a partial cross-section view of Section B of FIG. 4 the beverage infuser showing the friction element in its unlocked position;

FIG. 8 is a top plan view of a beverage infuser constructed in accordance with another preferred embodiment of the invention;

FIG. 9 is a cross-sectional view along the lines A-A of FIG. 8;

FIG. 10 is a cross-sectional view similar to the view of FIG. 8, in which the sleeve is moved outwardly from it's locked position;

FIGS. 11(a) and 11(b) show a cross-sectional exploded view of another embodiment of the positive locking mechanism of the present invention;

FIG. 12 shows a cross-sectional view of another embodiment of the positive locking mechanism of the present invention where the sleeve is shown separate from the body;

FIGS. 13(a) and 13(b) shows a cross-sectional exploded view of another embodiment of the positive locking mechanism of the present invention;

FIG. 14 show a cross-sectional view of another embodiment of the positive locking mechanism of the present invention where the sleeve is shown separate from the body;

FIG. 15 shows a cross-sectional view of another embodiment of the positive locking mechanism of the present invention where the sleeve is shown separate from the body;

FIGS. 16(a) and 16(b) shows a cross-sectional exploded view of another embodiment of the positive locking mechanism of the present invention;

FIGS. 17(a) and 17(b) shows a cross-sectional exploded view of another embodiment of the positive locking mechanism of the present invention;

FIG. 18 shows a cross-sectional view of another embodiment of the positive locking mechanism of the present invention where the sleeve is shown separate from the body; and

FIG. 19 shows a cross-sectional view of another embodiment of the projecting member of the present invention.

### DETAILED DESCRIPTION OF THE PREFERRED EMBODIMENTS

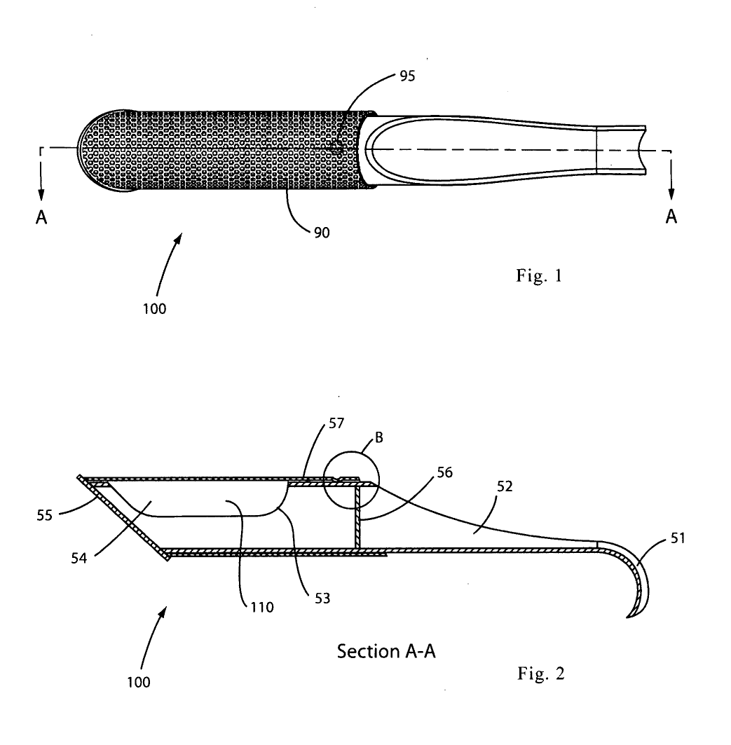

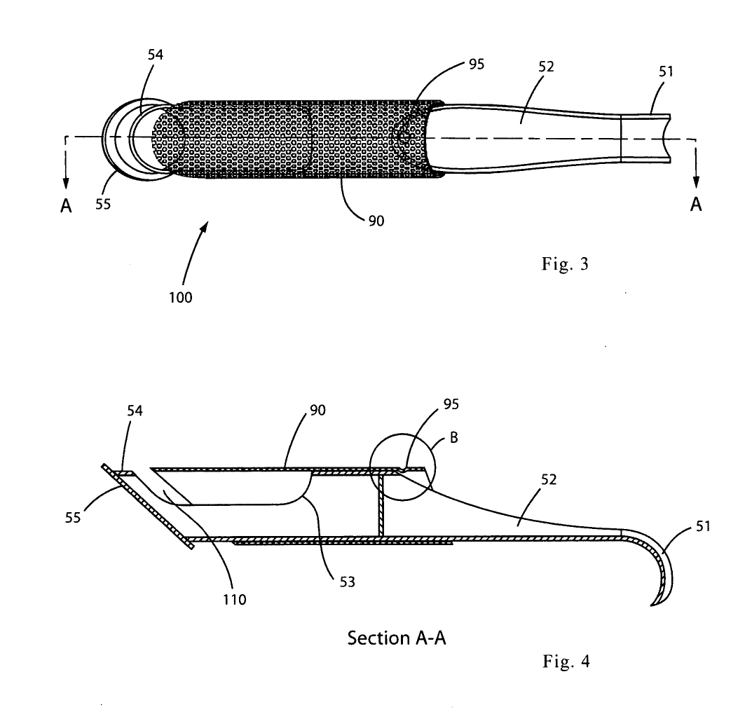

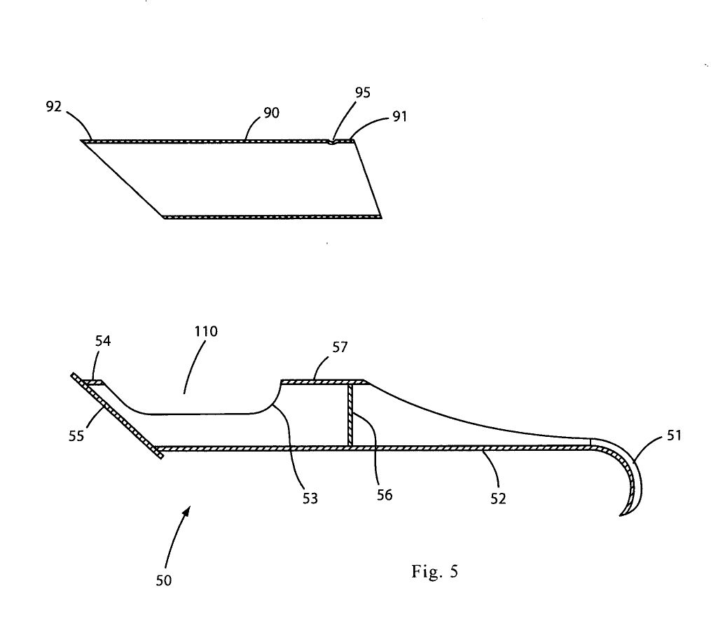

Reference is next made to FIGS. 1-5, wherein a beverage infuser, generally identified as 100 constructed in accordance with a preferred embodiment of the invention is depicted. Beverage infuser 100 includes a main body portion 50 and a sleeve 90, shown separately in FIG. 5. Sleeve 90 contains a first end 91 and a second end 92. Sleeve 90 operates by sliding from its closed and sealed position shown in FIGS. 1 and 2 to an open position as shown in FIGS. 3 and 4. In practice, the open position is much wider open than that shown in FIGS. 3 and 4 as the sleeve 90 will continue to slide all the way down main body portion 50 until prevented from going any further by the curve of handle region 51. Main body 50 of the infuser is made from a solid material, currently preferably stainless steel, and has four main distinct regions. It has handle region 51, which functions as a way to hold the infuser 100 with your hand and also allows it to be hung from the rim of a glass or mug when it is in a tall glass or wide mug. It also allows the infuser 100 to sit on the table without spilling the contents therein. Finally, it creates a “stop” so that the sleeve cannot be easily removed or lost from the main body 50.

The second component of infuser 100, upper sliding region 52, is primarily responsible for the smooth operation of infuser 100 in a back and forth sliding motion of sleeve 90. It allows sleeve 90 to rotate, which some people prefer to one-handed operation of the infuser.

Next, scooping region 53 is an area where tea leaves or other materials can be scooped into main body 50 of infuser 100 before the sleeve is closed so that it can infuse tea while containing the leaves within the device. Scooping region 53 defines an open volume 110 in the interior of main body 50 sized to hold the appropriate amount of tea for the size cup or glass intended as well as sufficient additional volume of water to allow the tea to steep or infuse the water properly and rapidly.

The fourth region is barb region 54, which is a thin region near end piece 55, which allows for tea leaves to enter the scooping region with a forward and backwards thrust rather than a sideways action. Since most tea tins are packed axially it is a preferred method of scooping tea leaves since it does not require tea leaves to be cut across their stems.

An end piece 55 is welded or otherwise secured to the bottom portion of the main body at the barb region. Finally, a plug 56 is a perforated screen placed within the diameter of the main body's tube at the top of sliding region 57 to prevent the tea leaves from escaping scooping region 53. It also allows easy cleaning of infuser 100 by forcing water through it from an outside source like a faucet. This plug also allows for a circular path of infusion of the tea leaves. The water is able to flow over the top of the sliding region and out through the barb region.

Main body 50 thus defines an infusion chamber formed within the tube of sliding region 57, scooping region 53 and barb region 54 between end piece 55 and plug 56 in which the tea and additional volume is present. In the infusing position or sealed position sleeve 90 completely encloses the infusing volume 110 and water enters through the perforations in sleeve 90, but the tea leaves within the infusing volume 110 remain trapped inside.

Sleeve 90 is formed of a perforated material formed into a generally cylindrical shape with the end portion closest to plug 56 being cut on a bias so as to mate with the rim of plug 56, which is angled with respect to the length of sleeve 90 and the tube in the main body. In a current preferred embodiment, sleeve 90 is also formed of stainless steel. In this way the entire infuser 100 is formed of stainless steel and can be washed in the sink or water or dropped into a dishwasher without wearing, damaging or discoloring infuser 100. Sleeve 90 slides toward the handle region to expose the scooping region so that tea leaves may be put inside it. Afterwards, sleeve 90 slides back across the sliding region 57 to fully contain the leaves within the scooping region. The infuser is now ready to be put into a vessel of hot water so that it may brew the beverage as desired.

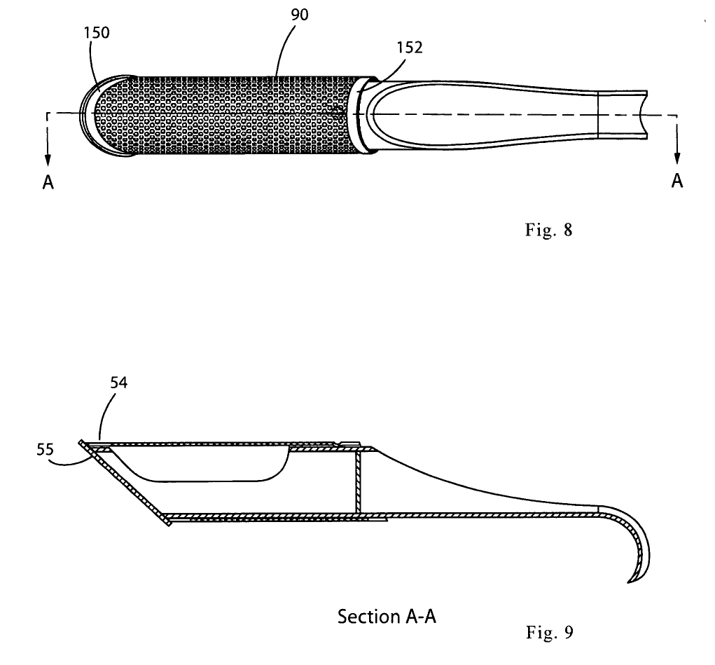

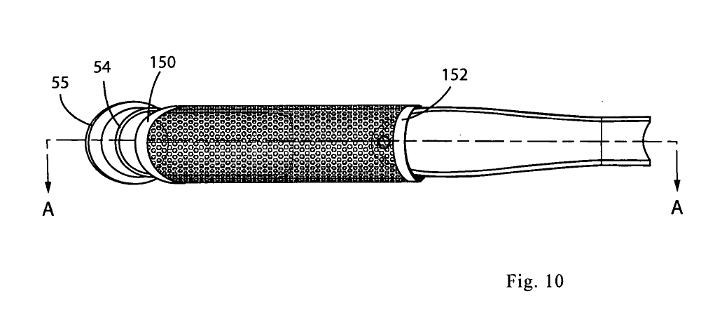

In another embodiment of sleeve 90 shown in FIGS. 8-10, sleeve 90 contains finished edges 150 and 152. These edges allow for a smoother feel to the user when sliding the sleeve between its opened and closed position. The finished edges also provide a more flush fit between end piece 55 and the sleeve.

One element of the design is the manner in which the sleeve reliably sits over the scooping region during brewing. Through the fit between main body 50 and sleeve 90 this fit can be made quite tight. However, there is the issue that if it is tight enough to resist sliding all of the distance, it is more difficult to use. Likewise, if the fit is too loose, sleeve 90 may slide and open up when put into a glass of tea and allow some of the tea leaves to escape, making for a big mess and an undesirable beverage. Finally, with a continuous-fitting system like sleeve 90 and main body 50, it is usually desirable for the user to feel a “positive lock” so that they know that the sleeve has been properly closed.

One method of creating this is to deform the tip of sleeve 90 nearest the end piece. This could generally be done with a rubber mallet as a final fitting operation. However, by doing so, this distorts sleeve 90 in such a way that it reduces the effective diameter in the area proximate the barb region. Since this effective diameter is reduced to a measurement less than the effective diameter of the barb region itself, an interference fit condition is created. This interference fit creates a frictional lock at the barb region.

While this method is successful in allowing the sleeve to slide freely in all but the final closing positions, creates a successful frictional lock and gives the consumer the feel of a “positive lock,” the system is not as reliable as desired. If, during manufacture, the tip is bent out of round too much, this would allow leaves to escape through the sides of the supposedly closed scooping region. In extreme cases, it could damage the sleeve to be unsightly and difficult to operate. Over time, the tip of the sleeve has a tendency to relax and the fit gets progressively looser, losing the benefits of such tip. Finally, infuser 100 is a very precision-oriented design and attempts to control the operation designed by creating an imprecision with the bang of a mallet is neither aesthetically desirable nor functionally practical.

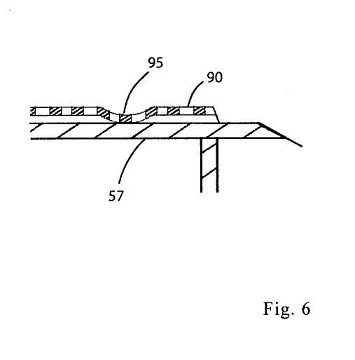

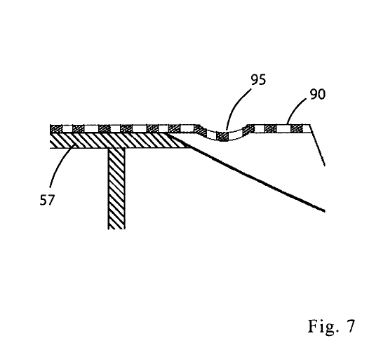

Accordingly, as shown in FIGS. 6 and 7, Applicant has developed a new and improved system for assuring that the sleeve 90 feeds positively on the end cap 55 proximate barb region 54. The present invention includes a friction enhancing element such as a projecting member or dimple. As seen in the detail drawings of FIGS. 6 and 7, sleeve 90 has a dimpling 95 at first end 91 which creates an interference fit within the sliding region. The back end of the sleeve, where dimple 95 is to be formed is put into a machine press that puts a 4-5 mm diameter dimple, preferably, into the top of the perforated sleeve to form a very small region with very great accuracy. By putting this type of circular depression in the sleeve made of small circles the dimple is well camouflaged and fits well esthetically as a precise solution in a precise object. The curvature and size of the dimple 95 is also established in a way which is less likely to interfere with the operation of the infuser 100 or to lose its functionality over time as was present with the hammered tip approach. The dimple in the sleeve operates in a fashion where it only makes its interference fit during the last millimeters of movement of the sleeve 90 unto the sliding region 57. As seen, the dimple 95 is located very close to the edge of sleeve 90. When the sleeve 90 is in the scooping position the dimple is close to the handle region 51 and does not in any way affect the operation of the system. Only as the last few millimeters of movement of the sleeve 90 is affected does the dimple 95 make contact with sliding region 57. Thus it allows the sleeve 90 to slide freely in all but the final approach to the sealed position. It creates a successful frictional lock which maintains sleeve 90 in the locked position about the infusion volume 110. Finally, it gives the consumer the feeling of forming a “positive lock” as the user slides the sleeve 90 into its locked state.

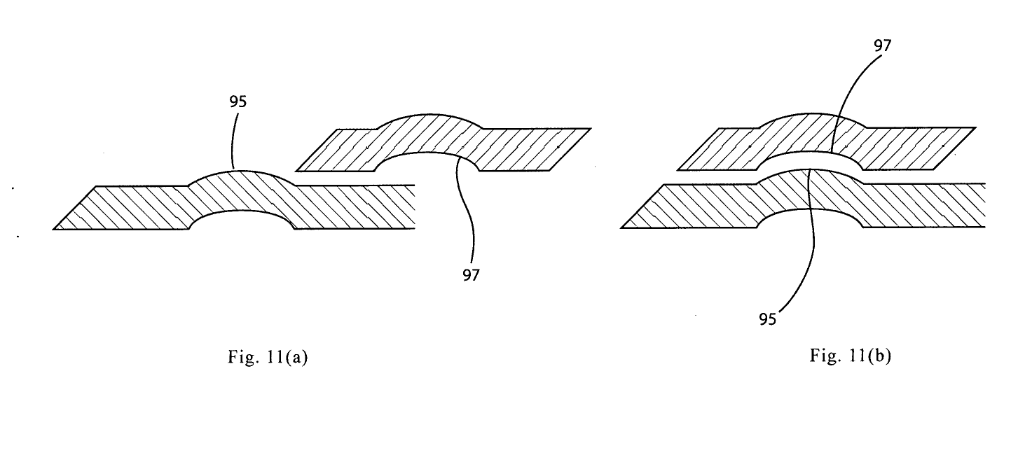

FIGS. 11-18 show other embodiments of the positive locking mechanism. FIG. 11 shows friction enhancing element 95 fitting into a crevice or detent 97 disposed in sliding region 57. This detent 97 allows for an even more secured locking as the projecting member 95 remains secured in detent 97 when in the closed position. Adding a detent 97 does not inhibit the sliding motion of sleeve 90 in any way.

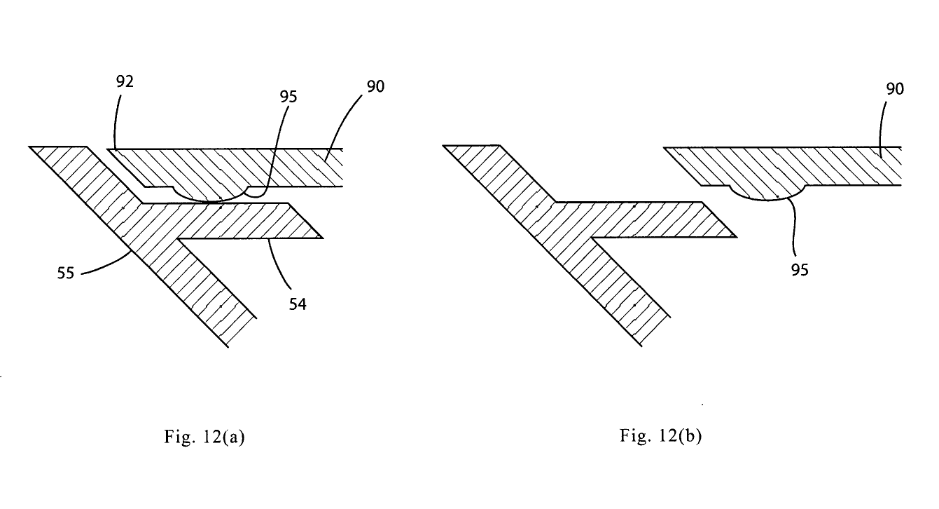

FIG. 12 shows an embodiment where projecting member 95 is located at the second end 92 of sleeve 90. This embodiment assures that there would be no disruption of sliding sleeve 90 along sliding region 57 because projection element 95 moves back and forth over scooping region 53 until locked into place with barb region 54.

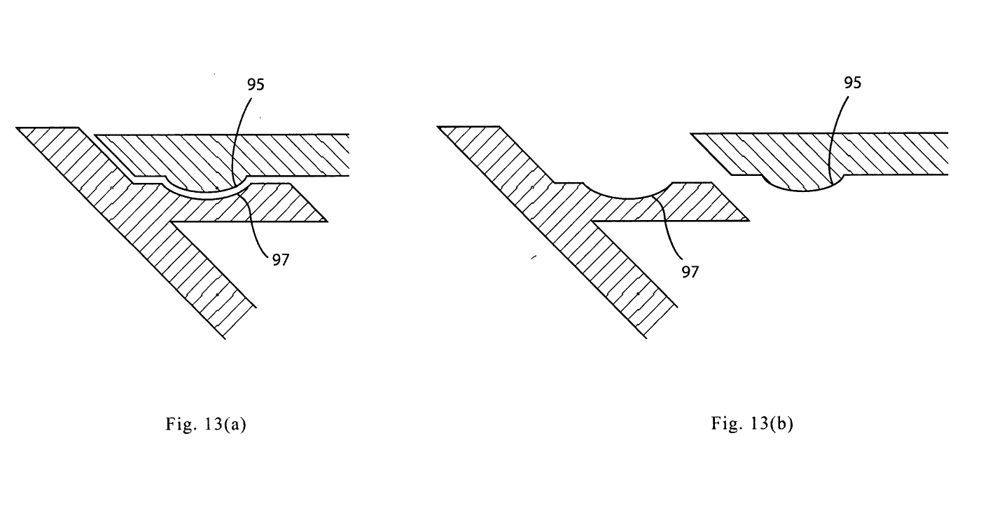

FIG. 13 shows projecting member 95 at the same end as in FIG. 12 and includes crevice or detent 97 on barb region 54. Again, as mentioned above, detent 97 allows for a more snug locking mechanism.

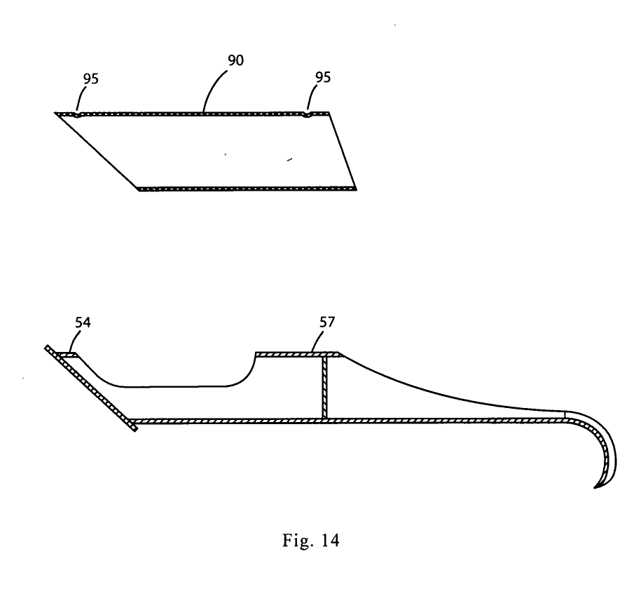

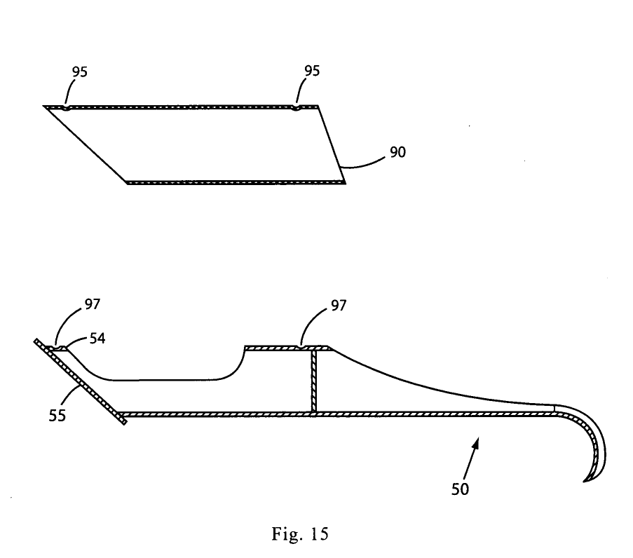

FIGS. 14 and 15 show the use of two projecting members 95, one located at each end of sleeve 90. FIG. 15 shows the addition of crevices 97 for fitting projecting members 95 in its closed position.

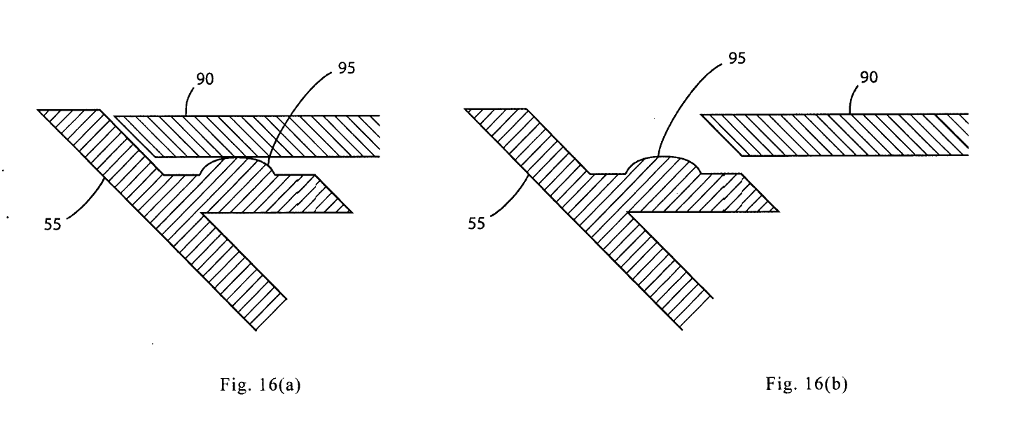

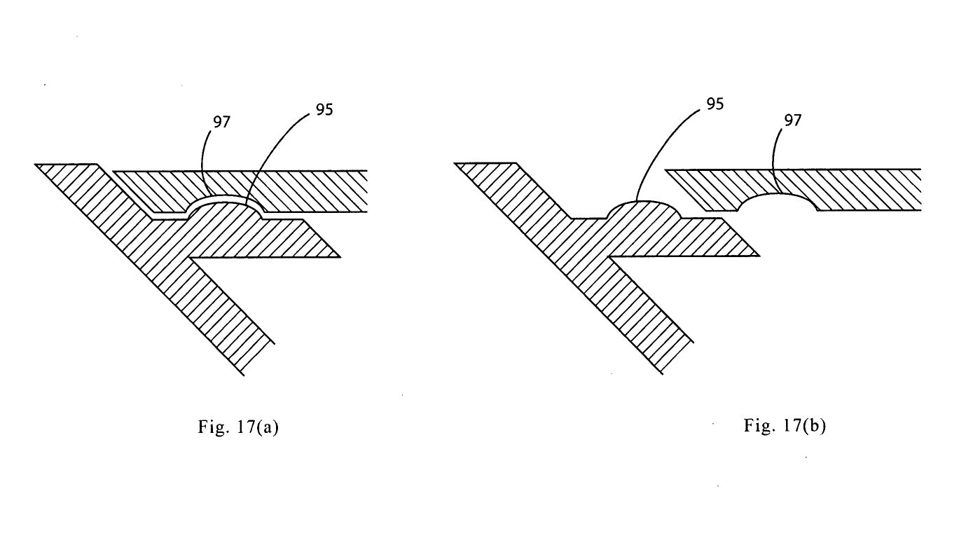

FIGS. 16 and 17 show projection member 95 being disposed on barb region 54. FIG. 17 further shows crevice 97 disposed at the second end of sleeve 90 for receiving projecting member 95.

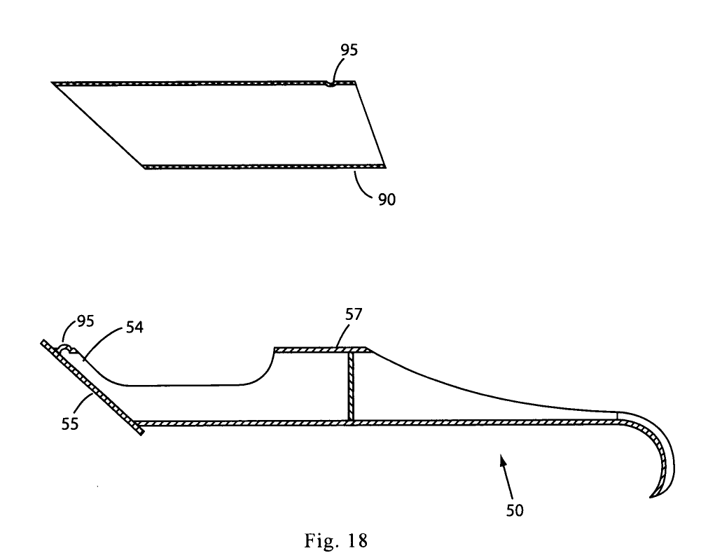

FIG. 18 shows an embodiment where the sleeve has projecting member 95 at first end 91 and main body 50 has a projecting member 95 on barb region 54.

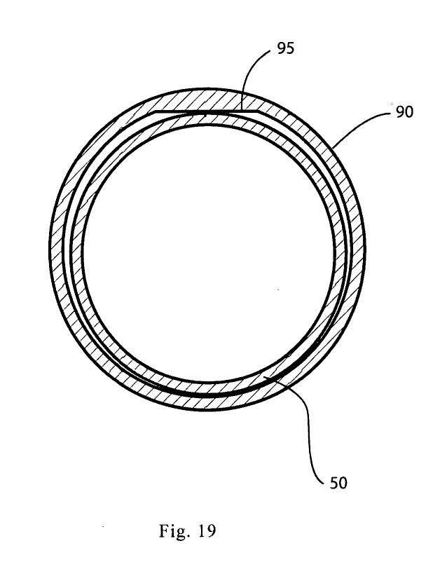

The present invention also contemplates various shapes for projecting member 95, such as s ridge shape, a triangle, etc. As shown in FIG. 19, projecting member 95 is a ridge shape disposed in sleeve 90.

In a current preferred embodiment of the invention the main body 50 is sized to have an outside diameter of 18.9 mm with the sleeve size to have an inside diameter of 19.4 mm. With the inside of dimple area 95 formed this creates an effective inside diameter of sleeve 90 at this point of 18.4 mm. This results in sleeve 90 freely sliding in the open position and an interference fit of 0.5 mm when the sleeve is in the closed position. This interference fit can be adjusted through a range of values but works reliably at a 0.5 mm differential.

Accordingly, an improved beverage infuser which includes a positively locking system for allowing the sleeve to slide freely between a scooping position and the locking position except for the final distance as well as creating a successful frictional lock and giving the user the feeling of a “positive lock” is provided.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall therebetween.

What is claimed is:

1. A beverage infuser, comprising:
a main body having a handle region, an upper sliding region, a scooping region and a barb region;
a sleeve formed of perforated material which slides back and forth across the main body while retaining contact with the sliding region between an open scooping position and a closed locking position; and
a friction enhancing element formed in the sleeve for creating a positive lock between the sleeve and the main body.

2. The beverage infuser of claim 1 further comprising an end piece secured to a bottom portion of the main body proximate the barb region;

3. The beverage infuser of claim 1 further comprising a plug within the upper sliding region;

4. The beverage infuser of claim 1 wherein the sleeve comprises finished edges.

5. The beverage infuser of claim 1 wherein at least a portion of the sleeve comprises stainless steel.

6. The beverage infuser of claim 1 comprising stainless steel.

7. The beverage infuser of claim 1 wherein the friction enhancing element comprises a dimple means.

8. A beverage infuser, comprising:
a main body having a handle region, an upper sliding region, a scooping region and a barb region;
an end piece secured to a bottom portion of the main body proximate the barb region;
a plug within the upper sliding region;
a sleeve formed of perforated material which slides back and forth across the main body while retaining contact with the sliding region between an open scooping position and a closed locking position; and
a projecting member formed in the sleeve for creating a positive lock between the sleeve and the main body.

9. A beverage infuser, comprising:
a main body having a handle region, an upper sliding region, a scooping region and a barb region;
a sleeve, having a first end and a second end, and formed of perforated material which slides back and forth across the main body while retaining contact with the sliding region between an open scooping position and a closed locking position; and
a friction enhancing element disposed in at least one of the main body and the sleeve for creating a positive lock between the sleeve and the main body.

10. The beverage infuser of claim 9 further comprising an end piece secured to a bottom portion of the main body proximate the barb region;

11. The beverage infuser of claim 9 further comprising a plug within the upper sliding region;

12. The beverage infuser of claim 9 wherein the friction enhancing element is a projecting member.

11. The beverage infuser of claim 9 wherein the friction enhancing element is located on the first end of the sleeve.

12. The beverage infuser of claim 9 wherein the friction enhancing element is located on the second end of the sleeve.

13. The beverage infuser of claim 9 wherein the friction element is located on the barb region.

14. The beverage infuser of claim 9 wherein a crevice is disposed opposite the friction enhancing element for receiving the friction enhancing element.

15. The beverage infuser of claim 9 comprising a second friction enhancing element.

16. The beverage infuser of claim 15 comprising a second crevice for receiving the second enhancing element.

17. The beverage infuser of claim 9 wherein the friction enhancing element can be a variety of shapes.
